(19) United States
(12) Patent Application Publication
(10) Pub. No.: US 2026/0237775 A1
(43) Pub. Date: Aug. 13, 2026

(54) Cooling Control Apparatus and Cooling Control Method

(71) Applicant: LG Energy Solution, Ltd., Seoul (KR)

(72) Inventor: Tae-Cheol Jeong, Daejeon (KR)

(73) Assignee: LG Energy Solution, Ltd., Seoul (KR)

(21) Appl. No.: 19/532,007

(22) Filed: Feb. 6, 2026

(30) Foreign Application Priority Data
Feb. 7, 2025 (KR) 10-2025-0016080
Jan. 22, 2026 (KR) 10-2026-0013245

(51) Int. Cl. H01M 10/613; B60L 50/60; H01M 10/625; H01M 10/633; H01M 10/6567

(52) U.S. Cl. CPC H01M 10/613; B60L 50/60; H01M 10/625; H01M 10/633; H01M 10/6567; B60L 2240/545

(57) ABSTRACT

A cooling control apparatus includes a first coolant channel that cools a battery group of a battery pack; a second coolant channel that cools a relay box of the battery pack; an electronic valve provided in a communication portion between the first coolant channel and the second coolant channel, and controls each of the first coolant channel and the second coolant channel to be in an open state or in a closed state; a sensing circuit that measures a temperature of the battery group and a temperature of the relay box; and a controller that determines a first target state for the first coolant channel and a second target state for the second coolant channel based on the battery temperature and the relay temperature, and to output a valve control command indicating the first target state and the second target state to the electronic valve.

### CROSS-REFERENCE TO RELATED APPLICATIONS

This application is based on and claims priority from Korean Patent Application No. 10-2025-0016080 filed on Feb. 7, 2025 and Korean Patent Application No. 10-2026-0013245 filed on Jan. 22, 2026, with the Korean Intellectual Property Office, the disclosures of which are incorporated herein in their entirety by reference.

### TECHNICAL FIELD

The present disclosure relates to a cooling control apparatus and a cooling control method for a battery pack.

### BACKGROUND

Recently, as the demand for portable electronic products such as laptops, video cameras, and mobile phones has increased rapidly, and as the development of electric vehicles, energy storage batteries, robots, satellites, and the like has been carried out in earnest, research on high-performance batteries capable of repeated charging and discharging has been actively conducted.

Currently commercialized batteries include nickel-cadmium batteries, nickel-metal hydride batteries, nickel-zinc batteries, and lithium batteries. Among these, lithium batteries have attracted considerable attention due to their advantages over nickel-based batteries, such as minimal memory effect, which allows for more flexible charging and discharging, a very low self-discharge rate, and a high energy density.

### SUMMARY

The present disclosure provides an apparatus and a method for actively controlling individual cooling operations for a battery group and a relay box of a battery pack.

Other effects and advantages of the present disclosure may be understood by the following description and will become more apparent through embodiments of the present disclosure. In addition, it will be readily apparent that the effects and advantages of the present disclosure may be realized by the means and combinations thereof set forth in the claims.

A cooling control apparatus according to one aspect of the present disclosure is for a battery pack including a battery group and a relay box. The cooling control apparatus includes a first coolant channel that cools the battery group; a second coolant channel that cools the relay box; an electronic valve that is installed at a communication portion between the first coolant channel and the second coolant channel and controls each of the first coolant channel and the second coolant channel to be in an open state or a closed state; a sensing circuit that measures a battery temperature that is a temperature of the battery group and a relay temperature that is a temperature of the relay box; and a controller that determines a first target state for the first coolant channel and a second target state for the second coolant channel based on the battery temperature and the relay temperature and outputs a valve control command indicating the first target state and the second target state to the electronic valve.

When the battery temperature is equal to or higher than a first threshold temperature and the relay temperature is lower than a second threshold temperature, the controller may determine the first target state to be an open state and the second target state to be a closed state.

When the battery temperature is equal to or higher than a first threshold temperature and the relay temperature is lower than a second threshold temperature, the controller may determine both the first target state and the second target state to be open states.

When the battery temperature is equal to or higher than a first threshold temperature and the relay temperature is lower than a second threshold temperature, the controller may determine an opening level for the second coolant channel based on a temperature difference between the battery temperature and the relay temperature.

When the battery temperature is equal to or higher than a first threshold temperature and the relay temperature is equal to or higher than a second threshold temperature, the controller may determine the opening level for the second coolant channel by applying a predetermined negative correlation to the temperature difference when the relay temperature is lower than the battery temperature, and may determine the opening level for the second coolant channel by applying a predetermined positive correlation to the temperature difference when the relay temperature is higher than the battery temperature.

When the battery temperature is equal to or higher than a first threshold temperature and the relay temperature is lower than a second threshold temperature, the controller may determine an opening level for the second coolant channel based on a first temperature difference between the battery temperature and the first threshold temperature and a second temperature difference between the relay temperature and the second threshold temperature.

When the battery temperature is equal to or higher than a first threshold temperature and the relay temperature is lower than a second threshold temperature, the controller may determine the opening level for the second coolant channel by applying a predetermined negative correlation to a difference between the first temperature difference and the second temperature difference when the second temperature difference is less than the first temperature difference, and may determine the opening level for the second coolant channel by applying a predetermined positive correlation to the difference between the first temperature difference and the second temperature difference when the second temperature difference is equal to or greater than the first temperature difference.

When the battery temperature is equal to or higher than a first threshold temperature and the relay temperature is lower than a second threshold temperature, the controller may determine the first target state to be a closed state and the second target state to be an open state.

When the battery temperature is equal to or higher than a first threshold temperature and the relay temperature is lower than a second threshold temperature, the controller may determine both the first target state and the second target state to be closed states.

The cooling control apparatus may further include a coolant circulator communicating with an inlet and an outlet of the first coolant channel.

The electronic valve may be a three-port solenoid valve.

The sensing circuit may include a battery temperature sensor configured to measure the battery temperature and a relay temperature sensor configured to measure the relay temperature.

An electric vehicle according to another aspect of the present disclosure includes the cooling control apparatus.

A cooling control method according to another aspect of the present disclosure is for a battery pack including a battery group and a relay box. The cooling control method includes: measuring a battery temperature that is a temperature of the battery group, and a relay temperature that is a temperature of the relay box; determining, based on the battery temperature and the relay temperature, a first target state for a first coolant channel provided for cooling the battery group and a second target state for a second coolant channel provided for cooling the relay box; and outputting a valve control command indicating the first target state and the second target state to an electronic valve, wherein the electronic valve is installed at a communication portion between the first coolant channel and the second coolant channel and is configured to control each of the first coolant channel and the second coolant channel to be in an open state or a closed state.

The determining include determining the first target state to be an open state and the second target state to be a closed state when the battery temperature is equal to or higher than a first threshold temperature and the relay temperature is lower than a second threshold temperature.

The determining may include determining both the first target state and the second target state to be open states when the battery temperature is equal to or higher than a first threshold temperature and the relay temperature is equal to or higher than a second threshold temperature.

The determining may include determining an opening level for the second coolant channel based on a temperature difference between the battery temperature and the relay temperature when the battery temperature is equal to or higher than a first threshold temperature and the relay temperature is equal to or higher than a second threshold temperature.

A non-transitory computer-readable storage medium according to another aspect of the present disclosure records a program that causes a computer to execute the cooling control method.

According to at least one of the embodiments of the present disclosure, individual cooling operations for a battery group and a relay box of a battery pack may be actively controlled by changing the open/closed states of two coolant channels that are in communication with each other in accordance with respective temperatures of the battery group and the relay box. Accordingly, the space efficiency of the battery pack is increased, which is advantageous for weight reduction, compared to a passive method such as employing a large-sized relay box.

Further, according to at least one of the embodiments of the present disclosure, a limited supply amount of coolant may be appropriately distributed between the two coolant channels by adjusting an opening level of the coolant channel provided for cooling of the relay box based on the temperature of the battery group and the temperature of the relay box.

The effects of the present disclosure are not limited to those described above, and other effects not explicitly mentioned herein will be clearly understood by those skilled in the art from the description of the claims.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a diagram schematically illustrating a configuration of an electric vehicle including a cooling control apparatus according to one embodiment of the present disclosure.

FIG. 2 is a diagram referenced to describe an example of a coupling relationship between a battery pack and a sensing circuit illustrated in FIG. 1.

FIGS. 3 and 4 are diagrams referenced to describe an example of a coupling relationship between a cooling network, a coolant circulator, and an electronic valve illustrated in FIG. 1.

FIG. 5 is a flowchart referenced to schematically describe a cooling control method according to another embodiment of the present disclosure.

FIGS. 6 to 11 are flowcharts referenced to schematically describe various examples of subroutines that may be included in step S520 of FIG. 5.

FIG. 12 is a block diagram illustrating a hardware configuration for implementing a controller included in the cooling control apparatus according to one embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. The terms or words used in this specification and the claims should not be interpreted as being limited to their usual or dictionary meanings, but should be interpreted as having meanings and concepts that are consistent with the technical ideas of the present disclosure, based on the principles that the inventors may appropriately define the concepts of the terms to describe their invention in the best way possible.

Therefore, since the embodiments described in this specification and the configurations illustrated in the drawings are merely the most preferred embodiment of the present disclosure and do not represent all of the technical ideas of the present disclosure, it should be understood that various equivalents and modifications that may replace them at the time of filing may exist.

Terms including ordinal numbers such as "first" and "second" are used for the purpose of distinguishing any one of various components from the others, and are not used to limit the components by these terms.

When a certain part is described to "include" a certain component throughout the specification, this means that other components may also be included unless specifically stated otherwise, rather than excluding other components. Further, terms such as "unit" described in the specification refer to a unit that processes at least one function or operation, and may be implemented by hardware, software, or a combination of hardware and software.

Furthermore, when a certain portion is said to be "connected" to another portion throughout the specification, this includes not only a case where they are "directly connected" but also a case where they are "indirectly connected" with another element interposed therebetween.

A battery pack for a battery system requiring a large capacity and a high voltage (e.g., an electric vehicle or an energy storage system) may include a battery group and a relay box.

The battery group may include several to hundred battery cells connected in series, in parallel, or in a series-parallel combination, and when proper cooling fails, so-called "thermal propagation," in which a thermal runaway of the battery cells occurs sequentially, may arise.

Accordingly, cooling for the relay box has been relatively neglected, compared to the cooling for the battery group. However, as the need for rapid charging technologies for the battery pack continues to increase, dangerous situations in which heat generation of the relay box becomes significantly severe during charging and discharging of the battery group have been occurring frequently.

In order to suppress heat generation of the relay box, passive cooling methods such as employing a large-sized bus bar or attaching thermal pads to the inside and outside of the relay box may be considered, but these methods have a disadvantage in that it is difficult to effectively deal with the constantly changing temperature conditions of the relay box.

In view of these issues, the present disclosure provides a technology capable of actively controlling individual cooling operations for a battery group and a relay box of a battery pack by changing the open/closed states of two coolant channels that are in communication with each other in accordance with respective temperatures of the battery group and the relay box. Accordingly, the space efficiency of the battery pack is increased, which is advantageous for weight reduction, compared to a passive method such as employing a large-sized relay box.

Hereinafter, a cooling control apparatus and method according to embodiments of the present disclosure will be described in detail with reference to the drawings.

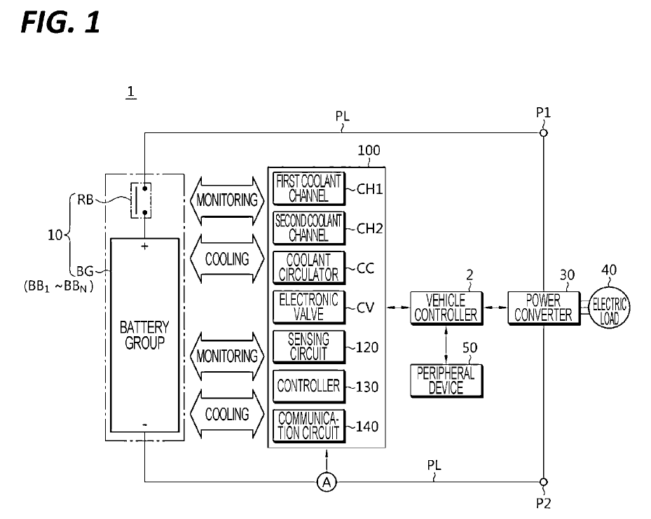

FIG. 1 is a diagram schematically illustrating the configuration of an electric vehicle including a cooling control apparatus according to one embodiment of the present disclosure.

Referring to FIG. 1, the electric vehicle 1 may include a battery pack 10, a vehicle controller 2, a power converter 30, an electric load 40, and a cooling control apparatus 100. The electric vehicle 1 may further include a peripheral device 50.

The battery pack 10 includes a battery group BG and a relay box RB. The battery group BG and the relay box RB may be connected in series between a first charge/discharge terminal P1 and a second charge/discharge terminal P2.

The battery group BG includes a plurality of battery blocks BB₁to BB_{N}, where N is a natural number of 2 or greater. The plurality of battery blocks BB₁ to BB_{N} may be connected to each other in series, in parallel, or in a series-parallel combination. In the present disclosure, when describing matters common to each of the plurality of battery blocks BB₁ to BB_{N}, a reference symbol "BB" or "BBₖ" is given to the battery block. The symbol k is a natural number not greater than N.

Each battery block BB includes at least one battery cell BC, and may be referred to by other terms such as "cell unit," "cell group," "cell array," or "cell assembly."

The battery block BB may include a single battery module or two or more battery modules. When the battery block BB includes a plurality of battery modules, the plurality of battery modules may be connected in series, in parallel, or in a series-parallel combination. Each battery module may include an assembly of two or more battery cells. When the battery module includes a plurality of battery cells, the plurality of battery cells may be connected in series, in parallel, or in a series-parallel combination.

In one embodiment, each of the plurality of battery blocks BB1 to BBN may include a separate case in which the battery cells BC included therein are accommodated. In this case, the plurality of battery blocks BB1 to BBN may be physically distinguished from each other by the respective cases thereof, and may be individually accommodated in or separated from a pack case of the battery pack 10.

In another embodiment, each of the plurality of battery blocks BB1 to BBN may be directly accommodated in the pack case of the battery pack 10 without a separate case. For example, each of the plurality of battery blocks BB1 to BBN may be formed by grouping, arbitrarily or according to specific criteria, the battery cells BC directly accommodated in the battery pack 10 individually or in groups of two or more, in consideration of a layout of the battery pack 10, a circuit connection with the cooling control apparatus 100, and the sensing ranges of a plurality of module monitoring units SB1 to SBN, among other factors. In this case, the battery pack 10 may have a cell-to-pack (CTP) structure from the viewpoint that the battery cells BC are directly accommodated in the pack case without individual cases of the plurality of battery blocks BB1 to BBN.

In this specification, the battery cell BC refers to a basic unit of a power storage element capable of individual charging and discharging, and is not particularly limited as long as it is rechargeable, such as a lithium-ion cell.

Referring to FIG. 1, the relay box RB is installed on a power line PL interconnecting the battery group BG and the charge/discharge terminals P1 and P2. In FIG. 1, the relay box RB is illustrated as being connected between a positive terminal of the battery group BG and the charge/discharge terminal P1, but the electric vehicle 1 may further include an additional relay box RB connected between a negative terminal of the battery group BG and the charge/discharge terminal P2. The relay box RB is controlled so as to be turned on and off in response to a switching signal from the cooling control apparatus 100 or the vehicle controller 2.

The relay box RB includes at least one relay, and may further include at least two bus bars. The relay may be a mechanical contactor that is turned ON and OFF by a magnetic force of a coil, or may be a semiconductor switch such as a metal oxide semiconductor field effect transistor (MOSFET). During charging or discharging of the battery group BG, at least one relay of the relay box RB may be maintained in an ON state. Both ends of each relay may be electrically connected to the power line PL via at least two bus bars.

The cooling control apparatus 100 according to one embodiment of the present disclosure includes a first coolant channel CH1, a second coolant channel CH2, an electronic valve CV, a sensing circuit 120, and a controller 130. The cooling control apparatus 100 may further include a communication circuit 140. The cooling control apparatus 100 may further include a coolant circulator CC.

The sensing circuit 120 according to one embodiment of the present disclosure generates monitoring information indicating respective states of the battery group BG and the relay box RB.

The sensing circuit 120 may measure the state parameters of each of the battery group BG and the relay box RB either periodically or non-periodically, and provide monitoring information indicating the respective measured state parameters to the controller 130.

The state parameters of the battery group BG may include, for example, a temperature of the battery block BBk (which may be referred to as a "block temperature"), a cell voltage of each battery cell BC included in the battery block BB, or secondary parameters derivable therefrom through application of a mathematical function (e.g., an amount of change and a rate of change). In the meantime, the type of the state parameters is not particularly limited as long as the parameters may directly or indirectly indicate the degree of thermal abnormality of the battery block BBₖ.

A current sensor A is installed on the power line PL interconnecting the battery pack 10 and the charge/discharge terminals P1 and P2 to measure a current flowing through the battery pack 10. The current sensor A may be included in the sensing circuit 120.

The controller 130, according to one embodiment of the present disclosure, may be implemented in hardware using at least one of application specific integrated circuits (ASICs), digital signal processors (DSPs), digital signal processing devices (DSPDs), programmable logic devices (PLDs), field programmable gate arrays (FPGAs), microprocessors, and other electrical units for performing functions. The controller 130 may be an independent device that may be manufactured, used, and/or sold separately from other components of the cooling control apparatus 100.

The controller 130 is operably coupled to at least one of the coolant circulator CC, the electronic valve CV, the sensing circuit 120, and the communication circuit 140. When two components are "operably coupled," it means that the two components are connected so as to be capable of transmitting and receiving signals in one direction or in both directions.

The controller 130 may include a memory device. The memory device may include at least one type of storage medium selected from a flash memory type, a hard disk type, a solid state disk (SSD) type, a silicon disk drive (SDD) type, a multimedia card micro type, a random access memory (RAM), a static random access memory (SRAM), a read-only memory (ROM), an electrically erasable programmable read-only memory (EEPROM), and a programmable read-only memory (PROM). The memory device may store instructions, data, and/or programs required for computational operations performed by the controller 130. The memory device may store data indicating results of computational operations performed by the controller 130.

The controller 130 may determine whether to execute a cooling control operation for the battery pack 10 based on the monitoring information received from the sensing circuit 120. Specifically, the controller 130 may execute the cooling control operation when a temperature of the battery group BG (e.g., a battery temperature) is equal to or higher than a first threshold temperature, or when a relay temperature of the relay box RB is equal to or higher than a second threshold temperature. In the meantime, the controller 130 may stop the cooling control operation when the battery temperature, which is the temperature of the battery group BG, is lower than the first threshold temperature and the relay temperature, which is the temperature of the relay box RB, is lower than the second threshold temperature. The functions and structure of the controller 130 will now be described in more detail below.

The temperature of the battery group BG may be determined based on the block temperature of at least one of the plurality of battery blocks BB1 to BBN. For example, the controller 130 may determine the temperature of the battery group BG to be equal to a highest block temperature, a lowest block temperature, or an average block temperature of the plurality of battery blocks BB1 to BBN.

The power converter 30 according to one embodiment of the present disclosure may include at least one of a DC-AC inverter and a DC-DC converter. The power converter 30 may convert direct current power (e.g., discharge power) supplied from the battery pack 10 into alternating current power, and supply the converted power to the electric load 40 during discharge of the battery pack 10. The electric load 40 according to one embodiment may include a three-phase AC motor that generates kinetic energy for driving the electric vehicle 1.

The communication circuit 140 according to one embodiment of the present disclosure performs wired or wireless communication between the controller 130, the vehicle controller 2, the peripheral device 50, and/or the cooling control apparatus 100. The wired communication may be, for example, controller area network (CAN), and the wireless communication may be, for example, Zigbee or Bluetooth communication. In the meantime, the type of communication protocol is not particularly limited to the examples listed above as long as it supports wired or wireless communication.

The peripheral device 50 according to one embodiment of the present disclosure may include a vehicle sensor(s) that measures at least one parameter (e.g., a vehicle speed) related to the state of the electric vehicle 1. The peripheral device 50 may include an output device (e.g., a display and a speaker) that provides information, received from the controller 130 and/or the vehicle controller 2, in a form recognizable to a user. The peripheral device 50 may be driven using direct current power or alternating current power supplied from the power converter 30.

The first coolant channel CH1 and the second coolant channel CH2 may be collectively referred to as a "cooling network." The cooling network provides a cooling function for at least one of the battery group BG and the relay box RB while a flow of coolant occurs through at least one coolant path provided therein. As the coolant, any one or a combination of two or more of known substances that cause a cooling action, such as water, carbon dioxide, ammonia, and non-conductive liquids, may be used. For example, in addition to the cooling action, any one or a combination of two or more of known substances having non-combustibility and/or non-flammability may be used as the coolant.

Although the battery pack 10 and the cooling control apparatus 100 are illustrated as being physically independent in FIG. 1, the cooling control apparatus 100 may be included as a sub-component of the battery pack 10, for example.

Electric energy required for driving the cooling control apparatus 100 may be supplied from at least one of the plurality of battery blocks BB1 to BBN. For example, a separate voltage regulator (not illustrated) may generate a power supply voltage using the electric energy of the battery group BG and then, supply the generated power supply voltage to the cooling control apparatus 100, and each component of the cooling control apparatus 100 may be activated by the power supply voltage.

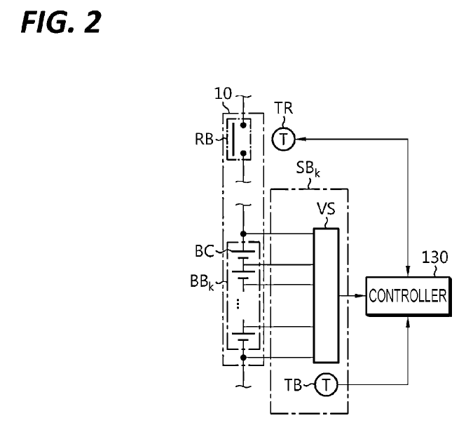

FIG. 2 is a diagram referenced to describe an example of a coupling relationship between the battery pack 10 and the sensing circuit 120 illustrated in FIG. 1. For convenience of description, FIG. 2 illustrates only the battery block BBₖ among the plurality of battery blocks BB1 to BBN included in the battery group BG.

Referring to FIG. 2, the sensing circuit 120 includes a relay temperature sensor TR that measures the relay temperature, which is the temperature of the relay box RB, and the module monitoring unit SBₖ provided in the battery block BBₖ. The relay temperature sensor TR is attached to an outer surface of the relay box RB or installed in an empty space within the relay box RB, and measures the relay temperature. The temperature sensor TR may generate a temperature signal indicating the relay temperature, and the controller 130 may collect the temperature signal from the temperature sensor TR.

The sensing circuit 120 may include the module monitoring unit SBₖ provided in the battery block BBₖ. Thus, the sensing circuit 120 may include a plurality of module monitoring units SB1 to SBN.

The module monitoring unit SBₖ may include a battery temperature sensor TB, and may further include a voltage detection circuit VS.

The battery temperature sensor TB is attached to an outer surface of the battery block BBₖ or installed at a predetermined point spaced apart from the battery block BBₖ to measure the temperature of the battery block BBₖ (e.g., the block temperature). The battery temperature sensor TB may generate a temperature signal indicating the temperature of the battery block BBₖ, and the controller 130 may collect the temperature signal from the battery temperature sensor TB.

The voltage detection circuit VS includes at least one voltage sensor. The voltage detection circuit VS may measure a module voltage of the battery block BBₖ. The module voltage is a voltage between both terminals of the battery block BBₖ. The voltage detection circuit VS may further measure a cell voltage of each battery cell BC included in the battery block BBₖ. The cell voltage is a voltage between both terminals of the battery cell BC. The voltage detection circuit VS may generate voltage signals indicating the module voltage of the battery block BBₖ and the cell voltages of the respective battery cells BC, and the controller 130 may collect the voltage signals from the voltage detection circuit VS.

The controller 130 may determine the state of charge (SOC) of each of the plurality of battery blocks BB1 to BBN and may further determine the state of health (SOH), based on monitoring information collected from the sensing circuit 120 (e.g., the above-described voltage signals, current signals, and temperature signals). Each of the SOC and the SOH may be estimated from one or a combination of two or more of various known techniques, and thus, an additional description thereof will be omitted.

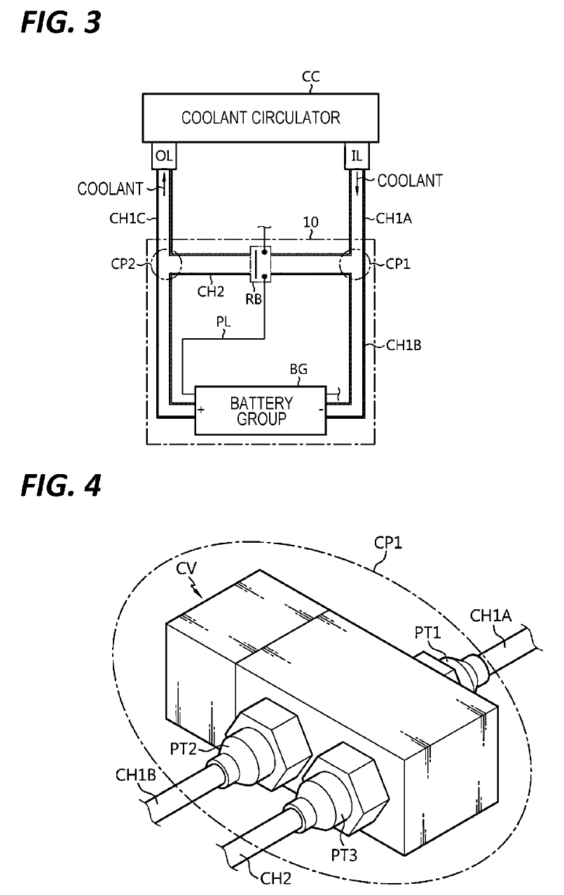

FIGS. 3 and 4 are diagrams referenced to describe an example of a coupling relationship between the cooling network, the coolant circulator, and the electronic valve illustrated in FIG. 1.

For ease of understanding, FIG. 3 illustrates the battery group BG and the relay box RB as being located on the upper side of the cooling network CH1 and CH2. Thus, in FIG. 3, a portion of the first coolant channel CH1 that is obscured by the battery group BG should be understood as being located at a lower end of the battery group BG, and similarly, a portion of the second coolant channel CH2 that is obscured by the relay box RB should be understood as being located at a lower end of the relay box RB.

Referring to FIG. 3, both ends of the first coolant channel CH1, which serves as a main coolant path among the first coolant channel CH1 and the second coolant channel CH2, are illustrated as being in communication with an inlet IL and an outlet OL provided in the coolant circulator CC.

The coolant circulator CC supplies the coolant to the cooling network CH1 and CH2 through the inlet IL. The coolant, which returns to the outlet OL of the coolant circuit CC after passing through the cooling network CH1 and CH2, may be supplied again to the cooling network CH1 and CH2 through the inlet IL after undergoing a heat dissipation process. The first coolant channel CH1 may be in contact with a portion of an outer surface of the battery group BG, and the battery group BG may be cooled by the flow of coolant through the first coolant channel CH1. Similarly, the second coolant channel CH2 may be in contact with a portion of the outer surface of the relay box RB, and the relay box RB may be cooled by the flow of coolant through the second coolant channel CH2.

The first coolant channel CH1 and the second coolant channel CH2 may be in communication with each other through two communication portions CP1 and CP2. The first coolant channel CH1 may be divided into three sub-coolant channels CH1A, CH1B, and CH1C on the basis of the two communication portions CP1 and CP2. The sub-coolant channel CH1A is a portion from the inlet IL to the communication portion CP1, the sub-coolant channel CH1B is a portion from the communication portion CP1 to the communication portion CP2, and the sub-coolant channel CH1C is a portion from the communication portion CP2 to the outlet OL.

The electronic valve CV may be installed to at least one of the two communication portions CP1 and CP2. The electronic valve CV may control each of the first coolant channel CH1 and the second coolant channel CH2 to be in an open state or in a closed state. As the electronic valve CV, for example, a three-port solenoid valve may be used. When the electronic valve CV is installed at only at least one of the two communication portions CP1 and CP2 (e.g., CP1), the first coolant channel CH1 and the second coolant channel CH2 may be directly connected to each other at the other communication portion (e.g., CP2).

FIG. 4 is a diagram referenced to describe an example coupling relationship between the electronic valve CV installed at the communication portion CP1, the first coolant channel CH1, and the second coolant channel CH2. Referring to FIG. 4, the electronic valve CV is provided with three ports PT1, PT2, and PT3. The three ports PT1, PT2, and PT3 are in communication with one end of the sub-coolant channel CH1A, one end of the sub-coolant channel CH1B, and one end of the second coolant channel CH2, respectively.

The electronic valve CV may change an open/closed state of a coolant passage between the port PT1 and the port PT2 and an open/closed state of a coolant passage between the port PT1 and the port PT3 in response to a valve control command from the controller 130.

When the coolant passage between the port PT1 and the port PT2 is opened, the first coolant channel CH1 is brought into an open state, thereby allowing the coolant to flow through the first coolant channel CH1. In the meantime, when the coolant passage between the port PT1 and the port PT2 is closed, the first coolant channel CH1 is brought into a closed state, thereby blocking the coolant from flowing through the first coolant channel CH1.

When the coolant passage between the port PT1 and the port PT3 is opened, the second coolant channel CH2 is brought into an open state, thereby allowing the coolant to flow through the second coolant channel CH2. In the meantime, when the coolant passage between the port PT1 and the port PT3 is closed, the second coolant channel CH2 is brought into a closed state, thereby blocking the coolant from flowing through the second coolant channel CH2.

The electronic valve CV may adjust an opening level (which may also be referred to as an "opening amount") of a specific coolant passage when opening the specific coolant passage. For example, assuming that the opening level of the specific coolant passage is 0 when the coolant passage is in a fully closed state, and the opening level of the specific coolant passage is 1 when the coolant passage is in a fully open state, the opening level of the specific coolant passage may be adjusted by the electronic valve CV within a range from 0 to 1.

As the opening level of the coolant passage between the port PT1 and the port PT2 increases, the flow rate of the coolant through the first coolant channel CH1 may increase, and as a result, the cooling rate of the battery group BG may increase.

As the opening level of the coolant passage between the port PT1 and the port PT3 increases, the flow rate of the coolant through the second coolant channel CH2 may increase, and as a result, the cooling rate of the relay box RB may increase.

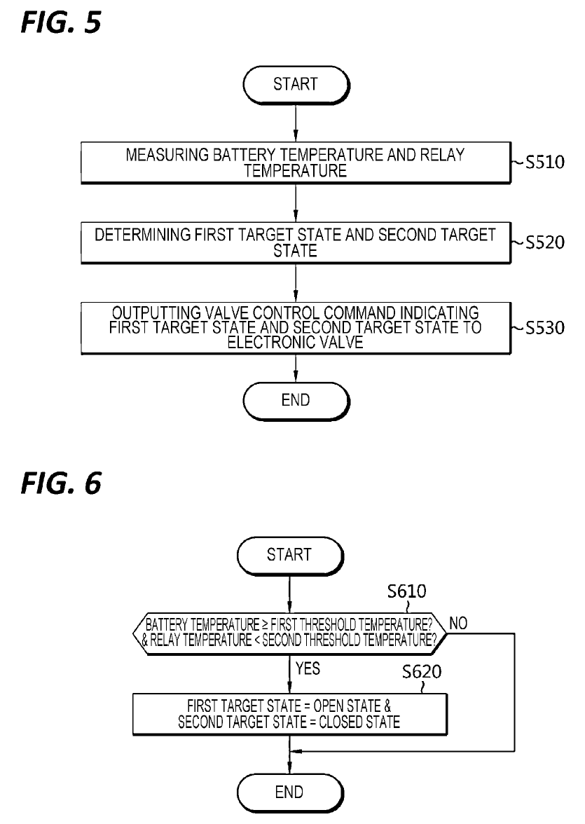

FIG. 5 is a flowchart referenced to schematically describe a cooling control method according to another embodiment of the present disclosure. The method according to FIG. 5 may be repeatedly performed either periodically or non-periodically during charging or discharging of the battery group BG.

Referring to FIGS. 1 to 5, in step S510, the controller 130 measures, by using the sensing circuit 120, the battery temperature, which is the temperature of the battery group BG, and the relay temperature, which is the temperature of the relay box RB (which may also be referred to as a "box temperature").

In step S520, the controller 130 determines a first target state for the first coolant channel CH1 and a second target state for the second coolant channel CH2 based on the battery temperature and the relay temperature.

In step S530, the controller 130 outputs a valve control command indicating the first target state and the second target state to the electronic valve CV. Accordingly, the electronic valve CV may change an open/closed state of the first coolant channel CH1 in accordance with the first target state, and may change an open/closed state of the second coolant channel CH2 in accordance with the second target state.

FIG. 6 is a flowchart referenced to schematically describe one example of subroutines that may be included in step S520 of FIG. 5.

Referring to FIG. 6, in step S610, the controller 130 determines whether the battery temperature is equal to or higher than a first threshold temperature and the relay temperature is lower than a second threshold temperature. The first threshold temperature may be determined in advance as a minimum temperature at which cooling for the battery group BG is required. The second threshold temperature may be determined in advance as a minimum temperature at which cooling for the relay box RB is required. When a determination result of step S610 is "Yes," step S620 is performed.

In step S620, the controller 130 determines the first target state as an open state, and the second target state as a closed state.

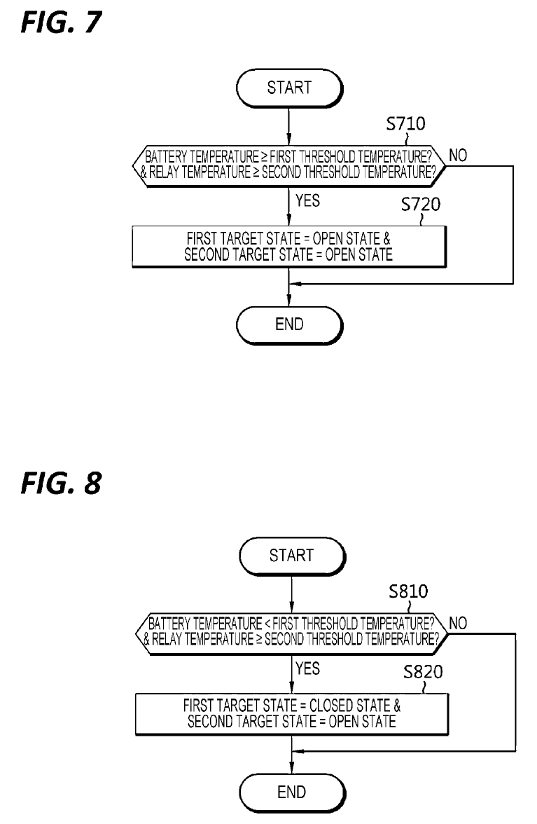

FIG. 7 is a flowchart referenced to schematically describe another example of subroutines that may be included in step S520 of FIG. 5.

Referring to FIG. 7, in step S710, the controller 130 determines whether the battery temperature is equal to or higher than the first threshold temperature and the relay temperature is equal to or higher than the second threshold temperature. When a determination result of step S710 is "Yes," step S720 is performed.

In step S720, the controller 130 determines both the first target state and the second target state as open states.

FIG. 8 is a flowchart referenced to schematically describe another example of subroutines that may be included in step S520 of FIG. 5.

Referring to FIG. 8, in step S810, the controller 130 determines whether the battery temperature is lower than the first threshold temperature and the relay temperature is equal to or higher than the second threshold temperature. When a determination result of step S810 is "Yes," step S820 is performed.

In step S820, the controller 130 determines the first target state as a closed state, and the second target state as an open state.

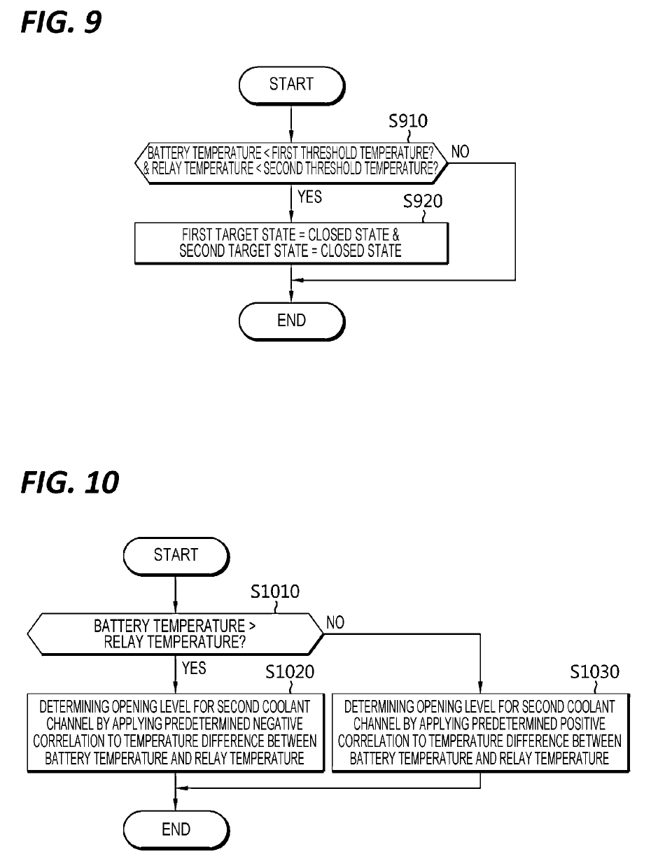

FIG. 9 is a flowchart referenced to schematically describe another example of subroutines that may be included in step S520 of FIG. 5.

Referring to FIG. 9, in step S910, the controller 130 determines whether the battery temperature is lower than the first threshold temperature and the relay temperature is lower than the second threshold temperature. When a determination result of step S910 is "Yes," step S920 is performed.

In step S920, the controller 130 determines both the first target state and the second target state as closed states.

Meanwhile, after step S720 of FIG. 7 is executed and then step S530 of FIG. 5 is executed, the coolant flows through both the first coolant channel CH1 and the second coolant channel CH2 by the operation of the electronic valve CV. In this regard, since the amount of coolant supplied per unit time from the coolant circulator CC is limited, it is necessary to control the supplied coolant so as to be appropriately distributed and flow through the first coolant channel CH1 and the second coolant channel CH2. Since the first coolant channel CH1 corresponds to a main coolant path, the opening level of the first coolant channel CH1 may be maintained at 1 (e.g., in a fully open state) while the first coolant channel CH1 is controlled to be in an open state.

FIG. 10 is a flowchart referenced to schematically describe another example of subroutines that may be included in step S520 of FIG. 5. The method of FIG. 10 may be executed in parallel with step S720 under the condition that the determination result of step S710 in FIG. 7 is "Yes."

Referring to FIG. 10, in step S1010, the controller 130 determines whether the relay temperature is lower than the battery temperature. A determination result of "Yes" in step S1010 may indicate a situation in which it is necessary to intensify cooling for the battery group BG, rather than cooling for the relay box RB. When a determination result of step S1010 is "Yes," step S1020 is performed. A determination result of "No" in step S1010 may indicate a situation in which it is more necessary to intensify cooling for the relay box RB compared to a case where the determination result of step S1010 is "Yes." When the determination result of step S1010 is "No," step S1030 is performed.

In step S1020, the controller 130 determines an opening level for the second coolant channel CH2 by applying a predetermined negative correlation to a temperature difference between the battery temperature and the relay temperature. For example, when the battery temperature is 70 °C and the relay temperature is 69 °C, the opening level corresponding to the temperature difference of 1 °C may be 0.20, and when the battery temperature is 72 °C and the relay temperature is 69 °C, the opening level corresponding to the temperature difference of 3 °C may be 0.18.

In step S1030, the controller 130 determines an opening level for the second coolant channel CH2 by applying a predetermined positive correlation to the temperature difference between the battery temperature and the relay temperature. For example, when the battery temperature is 70 °C and the relay temperature is 72 °C, the opening level corresponding to the temperature difference of 2 °C may be 0.40, and when the battery temperature is 70 °C and the relay temperature is 73 °C, the opening level corresponding to the temperature difference of 3 °C may be 0.45.

A signal or data indicating the opening level for the second coolant channel CH2 determined in step S1020 or step S1030 may be included in the valve control command output in step S530.

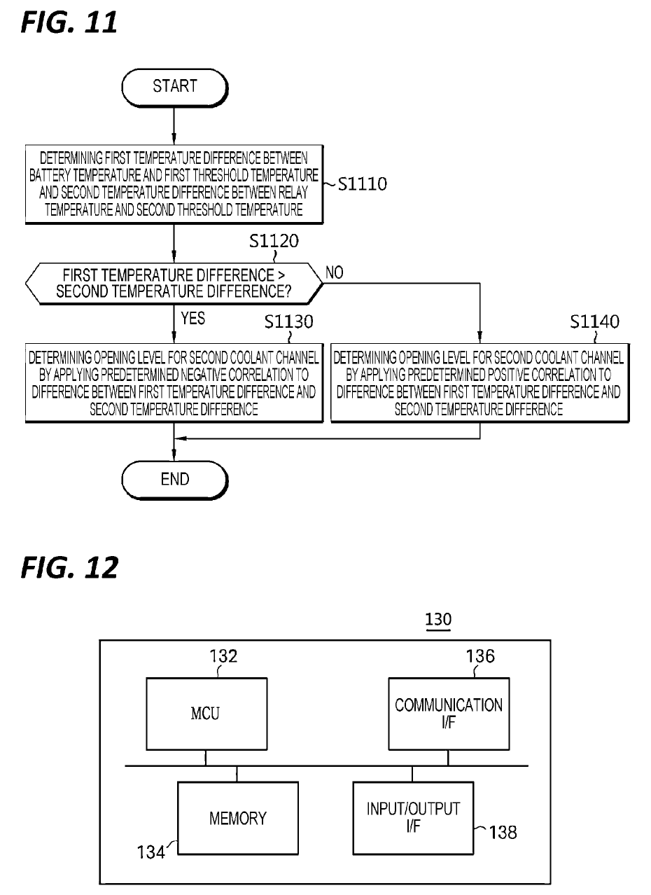

FIG. 11 is a flowchart referenced to schematically describe another example of subroutines that may be included in step S520 of FIG. 5. The method of FIG. 11 may be executed in parallel with step S720 under the condition that the determination result of step S710 in FIG. 7 is "Yes."

Referring to FIG. 11, in step S1110, the controller 130 determines a first temperature difference between the battery temperature and the first threshold temperature, and a second temperature difference between the relay temperature and the second threshold temperature.

In step S1120, the controller 130 determines whether the second temperature difference is less than the first temperature difference. A determination result of "Yes" in step S1120 may indicate a situation in which it is necessary to intensify cooling for the battery group BG, rather than cooling for the relay box RB. When a determination result of step S1120 is "Yes," step S1130 is performed. A determination result of "No" in step S1120 may indicate a situation in which it is more necessary to intensify cooling for the relay box RB compared to a case where the determination result of step S1120 is "Yes." When the determination result of step S1120 is "No," step S1140 is performed.

In step S1130, the controller 130 determines an opening level for the second coolant channel CH2 by applying a predetermined negative correlation to a difference between the first temperature difference and the second temperature difference. For example, when the battery temperature is 75 °C, the first threshold temperature is 70 °C, the relay temperature is 74 °C, and the second threshold temperature is 72 °C, the first temperature difference is 5 °C, the second temperature difference is 2 °C, and the difference between the first temperature difference and the second temperature difference is 3 °C. In this case, the opening level may be 0.35. When only the relay temperature becomes 73 °C under the same conditions, the difference between the first temperature difference and the second temperature difference is 4 °C. In this case, the opening level may be 0.29.

In step S1140, the controller 130 determines an opening level for the second coolant channel CH2 by applying a predetermined positive correlation to the difference between the first temperature difference and the second temperature difference. For example, when the battery temperature is 72 °C, the first threshold temperature is 70 °C, the relay temperature is 76 °C, and the second threshold temperature is 72 °C, the first temperature difference is 2 °C, the second temperature difference is 4 °C, and the difference between the first temperature difference and the second temperature difference is 2 °C. In this case, the opening level may be 0.47. When only the relay temperature becomes 78 °C under the same conditions, the difference between the first temperature difference and the second temperature difference is 4 °C. In this case, the opening level may be 0.53.

A signal or data indicating the opening level for the second coolant channel CH2 determined in step S1130 or step S1140 may be included in the valve control command output in step S530.

Each of the negative correlation used in step S1020 and step S1130 and the positive correlation used in step S1030 and step S1140 may be stored in a memory device in the form of a lookup table or a mathematical function. Examples of the mathematical function may include a linear regression equation, an exponential equation, and a polynomial equation.

FIG. 12 is a block diagram illustrating a hardware configuration for implementing the controller 130 included in the cooling control apparatus 100, according to one embodiment of the present disclosure.

The controller 130 according to one embodiment may include an MCU 132, a memory 134, a communication I/F 136, and an input/output I/F 138.

The MCU 132 is a micro-controller unit and serves as a processor that executes various programs stored in the memory 134, processes various data used by the programs, and performs the functions of the controller 130.

Another embodiment of the present disclosure may provide the memory 134, which is a computer-readable medium in which programs for causing a computer to perform the various embodiments described above are stored.

The programs may be implemented by hardware components, software components, and/or a combination of hardware components and software components. The programs may be executed by any system capable of executing computer-readable instructions.

Software may include computer programs, codes, instructions, or a combination thereof, and may configure each processing apparatus to operate as desired, or may instruct processing apparatuses independently or collectively.

The software may be implemented as a computer program including instructions stored in a computer-readable storage medium. Examples of the computer-readable storage medium include a magnetic storage medium (e.g., a read-only memory (ROM), a random-access memory (RAM), a floppy disk, and a hard disk) and an optical reading medium (e.g., a CD-ROM and a digital versatile disk (DVD)). The computer-readable storage medium may be distributed over network-connected computer systems such that computer-readable codes are stored and executed in a distributed manner. The storage medium may be readable by a computer, stored in a memory, and executed by a processor.

The computer-readable medium may be provided in the form of a non-transitory storage medium. Here, the term "non-transitory storage medium" refers only to a tangible device and does not include a signal (e.g., an electromagnetic wave). This term does not distinguish between a case where data is stored semi-permanently in the storage medium and a case where data is stored temporarily. For example, the "non-transitory storage medium" may include a buffer in which data is temporarily stored.

Further, the programs may be provided as a part of a computer program product. The computer program product may be traded between a seller and a purchaser as a commodity.

The computer program product may include a software program and a computer-readable storage medium in which the software program is stored. For example, the computer program product may include a product in the form of a software program (e.g., a downloadable application) that is electronically distributed through a manufacturer of an electronic device or an electronic marketplace. For electronic distribution, at least a part of the software program may be stored in the storage medium, or may be temporarily generated. In this case, the storage medium may be a storage medium of a server of the manufacturer of the electronic device, a server of the electronic marketplace, or a relay server that temporarily stores the software program.

The communication I/F 136 may be configured to transmit and receive various types of data to and from a server, and may include various devices capable of supporting wired or wireless communication. For example, the communication I/F 136 may transmit and receive programs, various types of data, and others for operating the controller 130 to and from an external server, which is separately provided, via wired or wirelessly communication.

The input/output I/F 138 may provide an interface that connects an input device (not illustrated) such as a keyboard, a mouse, or a touch panel and an output device (not illustrated) such as a display with the MCU 132 to enable data transmission and reception therebetween.

The embodiments of the present disclosure described above are not merely implemented only through an apparatus and a method, but may also be implemented through a program that realizes the functions corresponding to the configurations of the embodiments of the present disclosure, or through a storage medium in which the program is stored. Such implementations may be readily realized by those skilled in the art to which the present disclosure belongs, based on the description of the embodiments provided above.

Although the present disclosure has been described above with reference to the limited embodiments and drawings, the present disclosure is not limited thereto, and various modifications and variations may be made by those skilled in the art within the technical idea of the present disclosure and the equivalent scope of the claims set forth below.

In addition, since the present disclosure described above may be substituted, modified, and changed in various ways without departing from the technical spirit of the present disclosure by those skilled in the art, the present disclosure is not limited by the above-described embodiments and the accompanying drawings, and all or part of the embodiments may be selectively combined to form various modifications.

What is claimed is:

1. A cooling control apparatus comprising:
a first coolant channel configured to cool a battery group of a battery pack;
a second coolant channel configured to cool a relay box of the battery pack;
an electronic valve provided in a communication portion between the first coolant channel and the second coolant channel, and configured to control each of the first coolant channel and the second coolant channel to be in an open state or in a closed state;
a sensing circuit configured to measure a battery temperature that is a temperature of the battery group and a relay temperature that is a temperature of the relay box; and
a controller configured to determine a first target state for the first coolant channel and a second target state for the second coolant channel based on the battery temperature and the relay temperature, and to output a valve control command indicating the first target state and the second target state to the electronic valve.

2. The cooling control apparatus according to claim 1, wherein, when the battery temperature is equal to or higher than a first threshold temperature and the relay temperature is lower than a second threshold temperature,
the controller is configured to determine the first target state to be an open state and the second target state to be a closed state.

3. The cooling control apparatus according to claim 1, wherein, when the battery temperature is equal to or higher than a first threshold temperature and the relay temperature is equal to or higher than a second threshold temperature,
the controller is configured to determine both the first target state and the second target state to be open states.

4. The cooling control apparatus according to claim 3, wherein, when the battery temperature is equal to or higher than the first threshold temperature and the relay temperature is equal to or higher than the second threshold temperature,
the controller is configured to determine an opening level for the second coolant channel based on a temperature difference between the battery temperature and the relay temperature.

5. The cooling control apparatus according to claim 4, wherein, when the battery temperature is equal to or higher than the first threshold temperature and the relay temperature is equal to or higher than the second threshold temperature,
the controller is configured to:
determine the opening level for the second coolant channel by applying a predetermined negative correlation to the temperature difference when the relay temperature is lower than the battery temperature, and
determine the opening level for the second coolant channel by applying a predetermined positive correlation to the temperature difference if the relay temperature is higher than the battery temperature.

6. The cooling control apparatus according to claim 3, wherein, when the battery temperature is equal to or higher than the first threshold temperature and the relay temperature is equal to or higher than the second threshold temperature,
the controller is configured to determine an opening level for the second coolant channel based on a first temperature difference between the battery temperature and the first threshold temperature and a second temperature difference between the relay temperature and the second threshold temperature.

7. The cooling control apparatus according to claim 6, wherein, when the battery temperature is equal to or higher than the first threshold temperature and the relay temperature is equal to or higher than the second threshold temperature,
the controller is configured to:
determine the opening level for the second coolant channel by applying a predetermined negative correlation to a difference between the first temperature difference and the second temperature difference when the second temperature difference is less than the first temperature difference, and
determine the opening level for the second coolant channel by applying a predetermined positive correlation to the difference between the first temperature difference and the second temperature difference when the second temperature difference is equal to or greater than the first temperature difference,.

8. The cooling control apparatus according to claim 1, wherein, when the battery temperature is lower than a first threshold temperature and the relay temperature is equal to or higher than a second threshold temperature,
the controller is configured to determine the first target state to be a closed state and the second target state to be an open state.

9. The cooling control apparatus according to claim 1, wherein, when the battery temperature is lower than a first threshold temperature and the relay temperature is lower than a second threshold temperature,
the controller is configured to determine both the first target state and the second target state to be closed states.

10. The cooling control apparatus according to claim 1, further comprising:
a coolant circulator communicating with an inlet and an outlet of the first coolant channel.

11. The cooling control apparatus according to claim 1, wherein the electronic valve is a three-port solenoid valve.

12. The cooling control apparatus according to claim 1, wherein the sensing circuit includes a battery temperature sensor configured to measure the battery temperature and a relay temperature sensor configured to measure the relay temperature.

13. An electric vehicle comprising the cooling control apparatus according to claim 1.

14. A cooling control method comprising:
measuring a battery temperature of a battery group of a battery pack;
measuring a relay temperature of a relay box of the battery pack;
determining, based on the battery temperature and the relay temperature, a first target state for a first coolant channel configured to cool the battery group and a second target state for a second coolant channel configured to cool the relay box; and
outputting a valve control command indicating the first target state and the second target state to an electronic valve,
wherein the electronic valve is provided in a communication portion between the first coolant channel and the second coolant channel, and configured to control each of the first coolant channel and the second coolant channel to be in an open state or in a closed state.

15. The cooling control method according to claim 14, wherein the determining includes determining the first target state to be an open state and the second target state to be a closed state when the battery temperature is equal to or higher than a first threshold temperature and the relay temperature is lower than a second threshold temperature.

16. The cooling control method according to claim 14, wherein the determining includes determining both the first target state and the second target state to be open states when the battery temperature is equal to or higher than a first threshold temperature and the relay temperature is equal to or higher than a second threshold temperature.

17. The cooling control method according to claim 16, wherein the determining includes determining an opening level for the second coolant channel based on a temperature difference between the battery temperature and the relay temperature when the battery temperature is equal to or higher than a first threshold temperature and the relay temperature is equal to or higher than a second threshold temperature.

18. A non-transitory computer readable storage medium storing a program that causes a computer to perform a cooling control method, the method comprising:
measuring a battery temperature of a battery group of a battery pack;
measuring a relay temperature of a relay box of the battery pack;
determining, based on the battery temperature and the relay temperature, a first target state for a first coolant channel configured to cool the battery group, and a second target state for a second coolant channel configured to cool the relay box; and
outputting a valve control command indicating the first target state and the second target state to an electronic valve,
wherein the electronic valve is provided in a communication portion between the first coolant channel and the second coolant channel, and configured to control each of the first coolant channel and the second coolant channel to be in an open state or in a closed state.
